(19) United States
(12) Patent Application Publication
(10) Pub. No.: US 2016/0116642 A1
(43) Pub. Date: Apr. 28, 2016

(54) LAMINATE

(71) Applicant: MITSUBISHI RAYON CO. LTD., Chiyoda-ku, Tokyo (JP)

(72) Inventors: Kousuke FUJIYAMA, Otake-shi (JP); Tetsuya JIGAMI, Otake-shi (JP); Yusuke NAKAI, Otake-shi (JP); Seiichiro MORI, Toyohashi-shi (JP); Go OTANI, Otake-shi (JP)

(73) Assignee: MITSUBISHI RAYON CO., LTD., Chiyoda-ku, Tokyo (JP)

(21) Appl. No.: 14/891,715

(22) PCT Filed: May 21, 2014
(86) PCT No.: PCT/JP2014/063459

§ 371 Date: Nov. 17, 2015

(30) Foreign Application Priority Data
May 21, 2013 (JP) 2013-106734

(51) Int. Cl. G02B 1/118

(52) U.S. Cl. CPC G02B 1/118

(57) ABSTRACT

Provided is a laminate including a substrate and a surface layer laminated onto the substrate. The surface layer of the laminate has a microscopic asperity structure formed on the surface thereof on the opposite side from the substrate, this surface layer being a cured material obtained by curing of an active energy beam-curing composition. This active energy beam-curing composition is an active energy beam-curing composition containing particles that, where the interval between adjacent convex portions of the microscopic asperity structure is 100%, have an average particle diameter equal to 80% or more of this interval.

### TECHNICAL FIELD

The present invention relates to a laminate having a fine relief structure, and an antireflective article, a video device, and a touch panel using the laminate.

This application is based upon and claims the benefit of priority of the prior Japanese Patent Application No. 2013-106734, filed in the Japanese Patent Office on May 21, 2013, the entire contents of which are incorporated herein by reference.

### BACKGROUND ART

There is a problem that the visibility deteriorates at the interface (surface) at which various kinds of displays, lenses, and show windows are in contact with air since the surface reflects sunlight or lighting. As the method for decreasing the reflection, a method is known in which a number of films having different refractive indexes are laminated so that the light reflected from the film surface and the light reflected from the interface between the film and the substrate are canceled by the interference. These films are usually produced by a method such as sputtering, vapor deposition, or coating. However, by such a method, the reflectance and the wavelength dependence of reflectance are limitedly decreased although the number of laminated films is increased. Moreover, a material having a lower refractive index is required in order to decrease the number of laminated films so as to cut down the manufacturing cost.

It is effective to introduce air into the material in some way in order to decrease the refractive index of the material. By the way, a method to form a fine relief structure on the surface of a film is widely known as a method for decreasing reducing the refractive index of the film surface. According to this method, it is possible to greatly decrease the refractive index since the refractive index of the entire surface layer having a fine relief structure formed thereon is determined by the volume ratio of the material forming the fine relief structure to the air. As a result, it is possible to decrease the reflectance despite a smaller number of laminated films.

In addition, an antireflective film formed on a glass basal plate, in which a pyramid-shaped convex portion is continuously formed on the entire film is proposed (for example, see Patent Document 2). As described in Patent Document 2, an antireflective film having a pyramid-shaped convex portion (fine relief structure) formed thereon is an effective antireflective means since the cross-sectional area at the time of being cut in the film surface direction continuously changes and the refractive index gradually increases from the air side to the basal plate side. Moreover, the antireflective film exhibits excellent optical performance that cannot be replaced by other methods.

It is preferable that an antireflective film having a fine relief structure as described above has a uniform thickness in appearance. As the technique for exerting a uniform thickness, a technique to impart thixotropic nature to the film by adding particles to the composition forming the surface layer is known (for example, see Patent Document 1).

As a method for imparting abrasion resistance, a laminate is proposed in which the fine protrusions are composed of particles having an equivalent circle diameter of from 10 to 50 nm and a composition and the amount of the particles added is from 20 to 60% in a weight ratio is proposed (see Patent Document 2).

### CITATION LIST

### Patent Document

Patent Document 1: JP 2001-520683 W

Patent Document 2: JP 2009-20355 A

### SUMMARY OF THE INVENTION

### Problem to be Solved by the Invention

As described in Patent Documents 1 and 2, it is possible to obtain a laminate having a uniform film thickness by adding particles having an average particle size of 50 nm or less to the composition forming the surface layer, but there is a case in which the convex portions of the fine relief structure become hard brittle as the particles penetrate thereinto and thus the abrasion resistance deteriorates.

An object of the invention is to obtain a laminate which has a surface layer with a uniform film thickness and exhibits excellent abrasion resistance.

### Means for Solving Problem

An embodiment of the invention is a laminate which includes a surface layer having a surface having a fine relief structure formed thereon and in which the surface layer is a cured product of an active energy ray-curable composition and the active energy ray-curable composition contains particles having an average particle size to be equal to or greater than 80% of the interval between adjacent convex portions of the fine relief structure.

An embodiment of the invention is an antireflective article including the laminate.

An embodiment of the invention is an image display device (also referred to as a video device) including the laminate.

An embodiment of the invention is a touch panel including the laminate.

In other words, the invention relates to the following.

[1] A laminate including a substrate and a surface layer laminated on the substrate, in which

a fine relief structure is formed on a surface of the surface layer on a side opposite to a substrate side,

the surface layer is a cured product obtained by curing an active energy ray-curable composition, and

the active energy ray-curable composition is an active energy ray-curable composition containing particles having an average particle size to be equal to or greater than 80% of an average interval between adjacent convex portions of the fine relief structure, where the average interval is 100%.

[2] The laminate according to [1], in which the average particle size is from 100 to 1200% of the average interval between the adjacent convex portions of the fine relief structure, where the average interval is 100%.

[3] The laminate according to [1], in which the average interval between the adjacent convex portions of the fine relief structure is 25 nm or more and 400 nm or less.

[4] The laminate according to [1], in which the average particle size is from 80 to 2200 nm and the average interval between the adjacent convex portions is from 100 to 250 nm.

[5] The laminate according to any one of [1] to [4], in which the particles are at least one selected from the group consisting of silica (SiO₂), titanium dioxide (TiO₂), and a polymer containing at least one selected from the group consisting of methyl methacrylate and styrene.

[6] The laminate according to any one of [1], [1] to [4], in which a shape of the convex portion of the fine relief structure has a structure in which an occupancy rate of a cross-sectional area at the time of cutting a convex portion of the fine relief structure in a direction orthogonal to a height direction of the laminate continuously increases from a tip portion side of the convex portion of the fine relief structure toward a substrate side.

[7] The laminate according to any one of [1] to [6], in which a content of the particles is from 1 to 70 parts by mass with respect to 100 parts by mass of the active energy ray-curable composition.

[8] The laminate according to any one of [1] to [7], in which the active energy ray-curable composition has a content of a trifunctional or higher polyfunctional (meth)acrylate of 10 parts by mass or more and 60 parts by mass or less and a content of a bifunctional (meth)acrylate of 40 parts by mass or more and 90 parts by mass or less where a total amount of polymerizable components of the active energy ray-curable composition is 100 parts by mass.

[9] An antireflective article including the laminate according to [1].

[10] A video device including the laminate according to [1].

[11] A touch panel including the laminate according to [1].

### Effect of the Invention

According to the invention, it is possible to provide a laminate having a surface layer with a uniform thickness. In addition, according to the invention, it is possible to obtain a laminate exhibiting excellent abrasion resistance for friction with cloth and the like.

### BRIEF DESCRIPTION OF DRAWINGS

FIG. 1 is a cross-sectional diagram schematically illustrating an example of the configuration of a laminate that is an embodiment of the invention;

FIG. 2 is a cross-sectional diagram schematically illustrating an example of the configuration of a laminate that is an embodiment of the invention;

FIG. 3 is a schematic diagram illustrating an example of an antireflective article including a laminate that is an embodiment of the invention;

FIG. 4 is a schematic diagram illustrating an example of a video device including a laminate that is an embodiment of the invention; and

FIG. 5 is a schematic diagram illustrating an example of a touch panel including a laminate that is an embodiment of the invention.

### MODE(S) FOR CARRYING OUT THE INVENTION

Hereinafter, the invention will be described in detail.

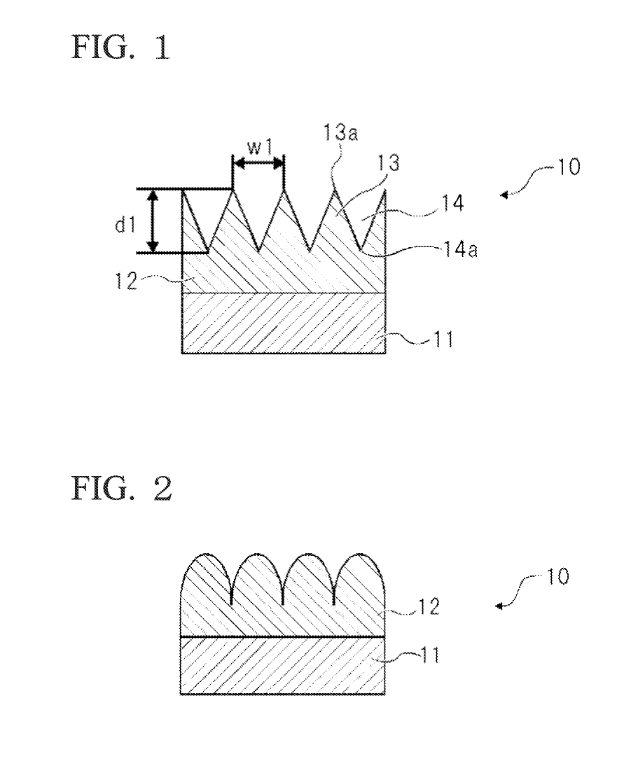

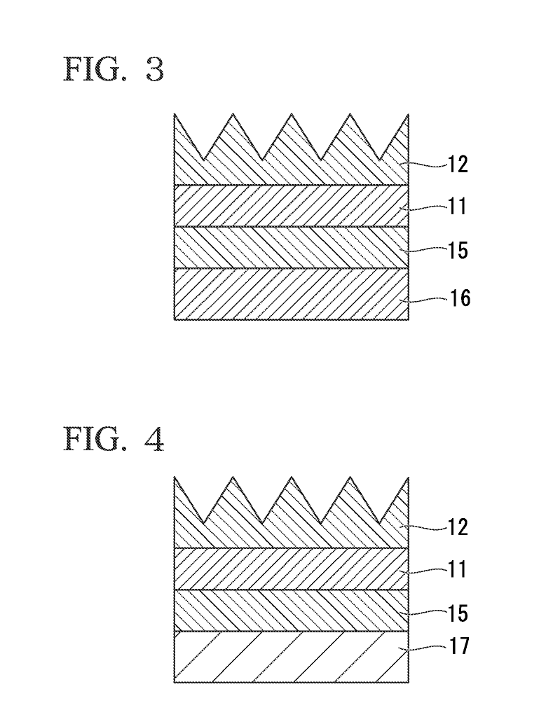

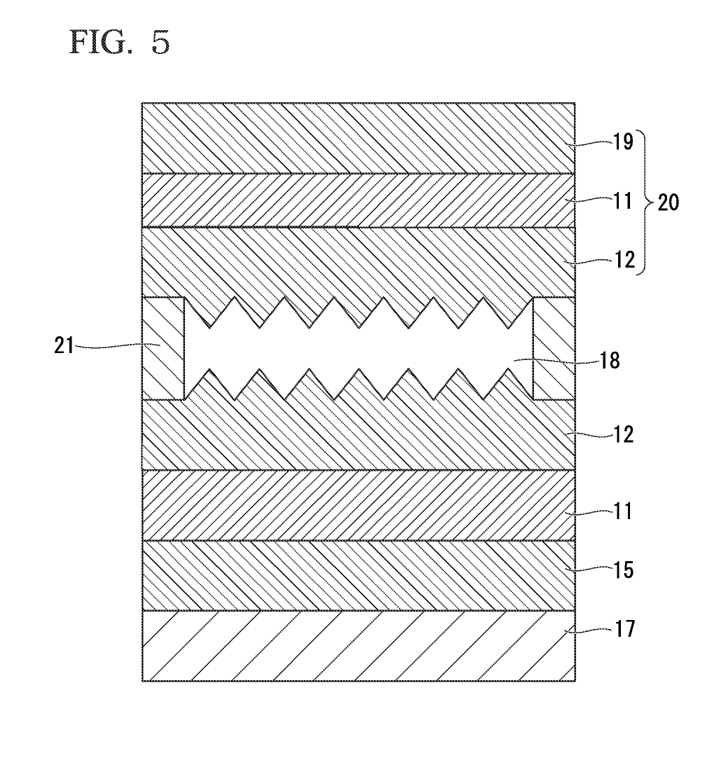

FIG. 1 is a cross-sectional diagram schematically illustrating an example of the configuration of a laminate 10 that is an embodiment of the invention. In FIG. 1, the laminate 10 has a structure in which a surface layer 12 composed of a cured product obtained by curing an active energy ray-curable composition is laminated on an optically transparent substrate 11. In the laminate 10, a fine relief structure is formed on the surface of the surface layer 12 (namely, the surface on the side opposite to the surface on which the surface layer 12 comes in contact with the substrate 11).

In the laminate 10, it is preferable that the fine relief structure is formed on the entire surface of the surface layer 12, but the laminate 10 may have a structure in which the fine relief structure is formed on a part of the surface of the surface layer 12. Moreover, in a case in which the laminate 10 has a film shape, a surface layer having a fine relief structure formed thereon may be laminated on both sides of the substrate 11.

It is preferable that the fine relief structure on the surface of the surface layer is formed using a stamper having a fine relief structure formed by self-assembly.

In the laminate of an embodiment of the invention, the surface layer is composed of a cured product obtained by curing an active energy ray-curable composition, and the active energy ray-curable composition contains particles having an average particle size to be equal to or greater than 80% and equal to or smaller than 8000% of the average interval between the adjacent convex portions of the fine relief structure formed on the surface of the surface layer, where the average interval is 100%. Preferably, the active energy ray-curable composition contains particles having an average particle size to be equal to or smaller than 2000% of the average interval. By containing the particles, thixotropic nature is imparted to the active energy ray-curable composition by intermolecular interaction of the particles and the active energy ray-curable composition can be coated on a substrate so as to have a uniform film thickness, and thus it is possible to obtain a laminate having a uniform film thickness after the surface layer is cured. Moreover, by setting the average particle size of particles contained in the active energy ray-curable composition to be equal to or greater than 80% of the interval between the adjacent convex portions of the fine relief structure formed by curing the active energy ray-curable composition, it is possible to suppress the penetration of the particles into the convex portions and to suppress the deterioration in abrasion resistance of the laminate after the curing.

Incidentally, the “uniform film thickness” in the “laminate having a uniform film thickness” described herein means the film thickness when the thickness of the surface layer (namely, the vertical distance from the apex of the convex portion of the fine relief structure formed on the surface of the surface layer to the interface between the surface layer and the substrate) is measured at arbitrary five locations of the laminate and the deviation of the respective values measured is 1 μm or less.

The film thickness of the surface layer is preferably from 1 to 50 μm and more preferably from 2 to 10 μm. It is preferable to set the thickness to be thick to the extent to which a problem on flexibility is not caused in a case in which the hardness of the surface is required. It is preferable to set the thickness to be thin to the extent to which the uniformity of the film thickness is not impaired in a case in which it is necessary to further increase the optical transmittance or decrease the haze.

The “thixotropic nature” described herein is a nature that the viscosity of a substance changes with the elapse of time and is a nature that the viscosity decreases as a stress is applied to a substance but the viscosity increases and the substance is in a solid state as the substance is at a standstill.

In the laminate of an embodiment of the invention, the particles contained in the surface layer composed of a cured product obtained by curing an active energy ray-curable composition is not particularly limited, but inorganic particles composed of silica (SiO₂) or titanium dioxide (TiO₂); organic particles composed of a polymer obtained using methyl methacrylate or styrene as a starting material; and the like are suitably used.

It is desirable that the refractive index of the active energy ray-curable composition in a state of being cured and the refractive index of the particles are close to each other in order to obtain favorable optical transparency, and inorganic particles composed of silica (SiO₂), organic particles composed of a polymer obtained using methyl methacrylate or styrene as a starting material, and the like are preferably used from that point of view.

In the laminate of an embodiment of the invention, the size of the particles contained in the surface layer is equal to or greater than 80% and equal to or smaller than 8000% of the average interval between the adjacent convex portions of the fine relief structure formed on the surface of the substrate layer, where the average interval is 100%, preferably from 100 to 1200% of the average interval between the adjacent convex portions of the fine relief structure, where the average interval is 100%, and more preferably from 100 to 300% of the average interval between the adjacent convex portions of the fine relief structure, where the average interval is 100%.

The penetration of the particles into the convex portions of the fine relief structure is suppressed and the abrasion resistance of the laminate is favorable as the average particle size is set to be equal to or greater than 80% of the average interval between the adjacent convex portions of the fine relief structure, where the average interval is 100%. In addition, the penetration of the particles into the convex portions is further suppressed and the abrasion resistance of the laminate is more favorable as the average particle size is set to be equal to or greater than 100% of the average interval between the adjacent convex portions of the fine relief structure, where the average interval is 100%. The dispersibility of the particles in the composition and the optical transparency of the surface layer after being cured are favorable as the average particle size is set to be equal to or smaller than 300% of the average interval between the adjacent convex portions of the fine relief structure, where the average interval is 100%.

Incidentally, the “average interval between the adjacent convex portions of the fine relief structure” described herein means the average value of the shortest distances between the apexes of adjacent convex portions of the fine relief structure formed on the surface layer.

The average interval between the adjacent convex portions of the fine relief structure is preferably 25 nm or more and 400 nm or less and more preferably 100 nm or more and 250 nm or less.

The “average particle size” in the invention means the particle size at 50% cumulative value in the particle size distribution determined by the laser analysis and scattering method. In addition, the penetration of the particles into the convex portions is further suppressed and the dispersibility of the particles in the active energy ray-curable composition or the optical transparency of the surface layer obtained by curing the active energy ray-curable composition is more favorable as the difference between the particle size at 10% converted value and the particle size at 90% converted value is smaller and the variation in the particle size is smaller although the particle size is not particularly limited in the invention. More specifically, it is preferable that the difference between the particle size at 10% converted value and the particle size at 90% converted value is 1 μm or less.

The average particle size is preferably from 80 to 2200 nm, and more preferably from 100 to 2000 nm, and even more preferably from 200 to 500 nm.

In addition, examples of the laminate of an embodiment of the present application include a laminate which includes a substrate and a surface layer laminated on the substrate and in which a fine relief structure is formed on a surface of the surface layer on a side opposite to a substrate side, the surface layer is a cured product obtained by curing an active energy ray-curable composition, the active energy ray-curable composition contains particles having an average particle size of from 80 to 2200 nm, and an average interval between the adjacent convex portions of the fine relief structure is from 100 to 250 nm.

Specific examples of such particles include silica particles such as SO-E1 (trade name, average particle size of 250 nm, manufactured by ADMATECHS CO., LTD.), SO-E2 (trade name, average particle size of 500 nm, manufactured by ADMATECHS CO., LTD.), SO-E3 (trade name, average particle size of 1000 nm, manufactured by ADMATECHS CO., LTD.), SO-E5 (trade name, average particle size of 1500 nm, manufactured by ADMATECHS CO., LTD.), and SO-E6 (trade name, average particle size of 2000 nm, manufactured by ADMATECHS CO., LTD.); titanium dioxide particles such as ST-41 (trade name, average particle size of 200 nm, manufactured by ISHIHARA SANGYO KAISHA LTD.); polymers such as XX-119B (trade name, average particle size of 270 nm, manufactured by SEKISUI PLASTICS CO., LTD.), SSX-101 (trade name, average particle size of 220 nm, manufactured by SEKISUI PLASTICS CO., LTD.), XX-109B (trade name, average particle size of 380 nm, manufactured by SEKISUI PLASTICS CO., LTD.), MBX-5 (trade name, average particle size of 1590 nm, manufactured by SEKISUI PLASTICS CO., LTD.), SSX-105 (trade name, average particle size of 450 nm, manufactured by SEKISUI PLASTICS CO., LTD.), and SSX-110 (trade name, average particle size of 690 nm, manufactured by SEKISUI PLASTICS CO., LTD.).

The silica particles contained in the surface layer preferably have a reactive group, and more preferably have a (meth)acrylic group from the viewpoint of curability with the active energy ray-curable composition to be described later. Examples of the method for introducing the reactive group include a surface treatment using a silane compound as represented by the following Formula.

SiR¹ₐR²_{b}(OR³)_{c}

(In Formula above, R¹ and R² are each independently represent a hydrocarbon residue which has from 1 to 10 carbon atoms and may have an ether bond, an ester bond, an epoxy bond, or a carbon-carbon double bond; R³ represents a hydrogen atom or a hydrocarbon residue which has from 1 to 10 carbon atoms and may have an ether bond, an ester bond, an epoxy bond, or a carbon-carbon double bond; a and b are each 0 or an integer from 1 to 3, and c is an integer from 1 to 4; provided that a+b+c=4.)

Such a silane compound is preferably used at a proportion of from 0 to 3 parts by mole with respect to 1 part by mole of the solid content of the silica particles. The hardness or abrasion resistance of the laminate decreases in some cases in a case in which the amount of the silane compound used exceeds 3 parts by mole.

Silica particles subjected to the surface treatment with a silane compound can be obtained by heating and stirring a silane compound and silica particles in the presence of a small amount of water.

As the method for adding the silica particles to the active energy ray-curable composition, it is possible to select an arbitrary method such as a method in which silica particles dispersed in water and an organic solvent are mixed with the active energy ray-curable composition before curing and the dispersion medium is then distilled off

The content of the particles is not particularly limited, but it is preferably from 1 to 70 parts by mass and more preferably from 30 to 70 parts by mass in a case in which the active energy ray-curable composition is set to 100 parts by mass. The thixotropic nature is imparted to the active energy ray-curable composition and the film thickness of the surface layer after curing is uniform when the content is 1 part by mass or more, and the dispersibility of the particles in the active energy ray-curable composition is favorable when the content is 70 parts by mass or less. In addition, the hardness of the active energy ray-curable composition after curing sufficiently increases and thus the abrasion resistance thereof is improved when the content is 30 parts by mass or more.

In the laminate of an embodiment of the invention, the surface layer is a cured product of an active energy ray-curable line composition, and the active energy ray-curable composition is not particularly limited, but it is preferable that the active energy ray-curable composition contains a monomer having a meth(acrylate) group from the viewpoint of curability by an active energy ray. It is preferable that the active energy ray-curable composition contains a trifunctional or higher polyfunctional (meth)acrylate (A) at from 10 to 60 parts by mass and a bifunctional (meth)acrylate (B) at 40 to 90 parts by mass when the sum of the polymerizable components in the active energy ray-curable composition is set to 100 parts by mass from the viewpoint of abrasion resistance after curing.

Examples of the trifunctional or higher polyfunctional (meth)acrylate (A) include a trifunctional monomer such as pentaerythritol tri(meth)acrylate, trimethylolpropane tri(meth)acrylate, trimethylolpropane ethylene oxide-modified tri(meth)acrylate, trimethylolpropane propylene oxide-modified triacrylate, trimethylolpropane ethylene oxide-modified triacrylate, or isocyanuric acid ethylene oxide-modified tri(meth)acrylate; a condensation reaction mixture of succinic acid/trimethylolethane/acrylic acid; and a polyfunctional monomer such as dipentaerythritol hexa(meth)acrylate, dipentaerythritol penta(meth)acrylate, ditrimethylolpropane tetraacrylate, or tetramethylolmethane tetra(meth)acrylate. These may be used singly or two or more kinds thereof may be used in combination.

Examples of the bifunctional (meth)acrylate (B) include ethylene glycol di(meth)acrylate, tripropylene glycol di(meth)acrylate, isocyanuric acid ethylene oxide-modified di(meth)acrylate, triethylene glycol di(meth)acrylate, diethylene glycol di(meth)acrylate, neopentyl glycol di(meth)acrylate, 1,6-hexanediol di(meth)acrylate, 1,5-pentanediol di(meth)acrylate, 1,3-butylene glycol di(meth)acrylate, polybutylene glycol di(meth)acrylate, 2,2-bis(4-(meth)acryloxypolyethoxyphenyl)propane, 2,2-bis(4-(meth)acryloxyethoxyphenyl)propane, 2,2-bis(4-(3-(meth)acryloxy-2-hydroxypropoxy)phenyl)propane, 1,2-bis(3-(meth)acryloxy-2-hydroxypropoxy)ethane, 1,4-bis(3-(meth)acryloxy-2-hydroxypropoxy)butane, dimethyloltricyclodecane di(meth)acrylate, bisphenol A ethylene oxide adduct di(meth)acrylate, bisphenol A propylene oxide adduct di(meth)acrylate, hydroxypivalic acid neopentyl glycol di(meth)acrylate, divinyl benzene, and methylenebisacrylamide. These may be used singly or two or more kinds thereof may be used in combination.

It is preferable that the trifunctional or higher polyfunctional (meth)acrylate (A) is from 10 to 60 parts by mass when the sum of the polymerizable components in the active energy ray-curable composition is set to 100 parts by mass. When the content of the trifunctional or higher polyfunctional (meth)acrylate (A) is 10 parts by mass or more, a sufficient elastic modulus is imparted to the convex portion of the fine relief structure and thus the coalescence of the convex portions can be prevented. When the content of the trifunctional or higher polyfunctional (meth)acrylate (A) is 60 parts by mass or less, sufficient flexibility is imparted to the convex portion of the fine relief structure and thus the abrasion resistance thereof is favorable.

It is preferable that the bifunctional (meth)acrylate (B) is from 40 to 90 parts by mass when the sum of the polymerizable components in the active energy ray-curable composition is set to 100 parts by mass. When the content of the bifunctional (meth)acrylate (B) is 40 parts by mass or more, sufficient flexibility is imparted to the convex portion of the fine relief structure and thus the abrasion resistance thereof is favorable. When the content of the bifunctional (meth)acrylate (B) is 90 parts by mass or less, a sufficient elastic modulus is imparted to the convex portion of the fine relief structure and thus the coalescence of the convex portions can be prevented.

In other words, in the active energy ray-curable composition, the content of the trifunctional or higher polyfunctional (meth)acrylate (A) is 10 parts by mass or more and 60 parts by mass or less and the content of the bifunctional (meth)acrylate (B) is 40 parts by mass or more and 90 parts by mass or less when the sum of the polymerizable components in the active energy ray-curable composition is set to 100 parts by mass.

In addition, it is also possible to add a viscosity modifier such as acryloyl morpholine or vinyl pyrrolidone; and an adhesion improving agent, such as an acryloyl isocyanate, which improves the adhesion of the active energy ray-curable composition to the light transmitting substrate to the active energy ray-curable composition.

The amount of the above components added is preferably from 0.1 to 30 parts by mass with respect to 100 parts by mass of the active energy ray-curable composition.

In addition, a polymer (oligomer) that is obtained by polymerizing one kind or two or more kinds of monofunctional monomers and has a low degree of polymerization may be added to the active energy ray-curable composition. Specific examples of such polymer having a low degree of polymerization include a monofunctional (meth)acrylate having a polyethylene glycol chain in an ester group (for example, “M-230G” (trade name), manufactured by Shin-Nakamura Chemical Co., Ltd.) or a 40/60 copolymerized oligomer of methacrylamidepropyltrimethylammonium methyl sulfate (for example, “MG polymer” (trade name) manufactured by MRC UNITECH Co., Ltd.).

Furthermore, an antistatic agent, a mold releasing agent, a ultraviolet absorber, and the like may be contained in the active energy ray-curable composition in addition to various kinds of the monomers or the polymer having a low degree of polymerization described above.

The active energy ray-curable composition may contain a mold releasing agent. It is possible to maintain favorable mold releasing property at the time of continuously producing the laminate when a mold releasing agent is contained in the active energy ray-curable composition. Examples of the mold releasing agent include a (poly)oxyalkylene alkyl phosphate compound. The mold releasing agent is easily adsorbed onto the surface of the mold as the (poly)oxyalkylene alkyl phosphate compound and alumina interact, particularly in the case of using an anodized alumina mold.

The (poly)oxyalkylene alkyl phosphate compound may be produced by a known method, or a commercially available product may be used.

Examples of the commercially available product include “JP-506H” (trade name) manufactured by JOHOKU CHEMICAL CO., LTD., “MOLD UIZ INT-1856” (trade name) manufactured by Axel Plastics Research Laboratories, Inc., and “TDP-10”, “TDP-8”, “TDP-6”, “TDP-2”, “DDP-10”, “DDP-8”, “DDP-6”, “DDP-4”, “DDP-2”, “TLP-4”, “TCP-5”, and “DLP-10” (all trade names) manufactured by Nikko Chemicals Co., Ltd.

The mold releasing agent contained in the active energy ray-curable composition may be used singly, or two or more kinds thereof may be used concurrently.

The content of the mold releasing agent contained in the active energy ray-curable composition is preferably from 0.01 to 2.0 parts by mass and more preferably from 0.05 to 0.2 part by mass with respect to 100 parts by mass of the polymerizable components in the active energy ray-curable composition. The mold releasing property of an article having a fine relief structure on the surface from the mold is favorable when the content of the mold releasing agent is 0.01 part by mass or more. Meanwhile, when the proportion of the mold releasing agent is 2.0 parts by mass or less, the adhesion between the cured product of the active energy ray-curable composition and the substrate is favorable, moreover, the hardness of the cured product is suitable, and the fine relief structure can be sufficiently maintained.

In the fine relief structure, it is preferable that the average value (average interval), w1, of the shortest distances between the tip portions of adjacent convex portions of the fine relief structure is preferably equal to or less than the wavelength of visible light, and it is more preferably 100 nm or more and 250 nm or less. It is possible to effectively prevent the protrusion coalescence of the convex portions by setting the average value to 100 nm or more. The average value is sufficiently smaller than the wavelength of visible light by being set to 250 nm or less, and thus the scattering of visible light is effectively suppressed and it is easy to impart excellent antireflective property.

Incidentally, the “wavelength of visible light” in the invention means a wavelength of 400 nm.

The average height, d1, of the convex portions 13 (for example, the average value of dl illustrated in FIG. 1) is preferably 100 nm or more and 400 nm or less and more preferably 150 nm or more and 250 nm or less. It is possible to prevent an increase in minimum reflectance or an increase in reflectance of a specific wavelength and it is easy to impart favorable antireflective property by setting the height, d1, to 100 nm or more.

The aspect ratio (average height, d1, of convex portions 13/average interval, w1, between the adjacent convex portions) is preferably from 0.5 to 5.0, more preferably from 0.6 to 2.0, and even more preferably from 0.8 to 1.2. It is possible to suppress an increase in minimum reflectance or an increase in reflectance of a specific wavelength and favorable antireflective property is exerted in a case in which the aspect ratio is 0.5 or more. In addition, the convex portions of the fine relief structure are hardly broken when the surface layer is rubbed in a case in which the aspect ratio is 5.0 or less, and thus favorable abrasion resistance or antireflective property is exerted.

Incidentally, the “average value (average interval) of the shortest distances between the tip portions of the convex portions” in the invention means a value obtained, for example, by measuring the shortest distance between the tip portions of the neighboring convex portions of the fine relief structure by electron microscopic observation at arbitrary 10 points and averaging these values.

Incidentally, the “average height of the convex portions” in the invention means a value obtained, for example, by measuring the distance in the vertical direction from a tip portion 13a of the convex portion 13 to a lowermost portion 14a of neighboring concave portions 14 as illustrated in FIG. 1 by electron microscopic observation at arbitrary 10 points and averaging these values.

In addition, the shape of the convex portion 13 of the fine relief structure is not particularly limited, but it is preferable that the shape has a structure such that the occupancy rate of the cross-sectional area at the time of cutting the convex portion 13 in a plane parallel to the film surface (namely, the cross-sectional area of the cut surface obtained by cutting the convex portion in the direction orthogonal to the height direction of the laminate) continuously increases from the tip portion side of the convex portion of the fine relief structure toward the substrate side as a substantially conical shape illustrated in FIG. 1, a bell shape as illustrated in FIG. 2, or the like in order to obtain an antireflective function that exhibits both a low reflectance and low wavelength dependency by continuously increasing the refractive index. In addition, a plurality of finer convex portions may form the fine relief structure through the protrusion coalescence.

In the laminate of an embodiment of the invention, the elastic modulus of the surface of the fine relief structure, namely, the indentation modulus of the surface layer is preferably 30 MPa or more and 500 MPa or less and more preferably from 50 to 100 MPa. The fine relief structure is sufficiently hard when the indentation modulus of the surface layer is 30 MPa or more, and thus it is possible to effectively prevent protrusion coalescence of the convex portions. The fine relief structure is soft when the indentation modulus of the surface layer is 500 MPa or less, and thus it is possible to force out the dirt that has entered the concave portion. The fine relief structure is sufficiently soft when the indentation modulus of the surface layer is 100 MPa or less, and thus it is possible to freely deform the fine relief structure and to easily remove the dirt that has entered the concave portion.

Incidentally, the “indentation modulus of the surface layer” described herein means a value measured by the following method. In other words, a transparent glass plate (“large glass slide, product number: 59112” manufactured by Matsunami Glass Ind., Ltd., size of 76 mm×52 mm) was pasted on the surface on the substrate side of a structural body via an optical adhesive to use this as a sample, and the measurement was conducted using a microindentation hardness testing machine (apparatus name: FISCHERSCOPE HM2000XYP manufactured by Fischer Instruments K.K.). The Vickers indenter (tetrahedral diamond pyramid) was used as the indenter, and the evaluation was conducted in a thermostatic chamber (temperature of 23° C., humidity of 50% RH). The evaluation program was set to [pushing (1 mN/s, 5 seconds]→[creeping (1 mN, 10 seconds)]→[load removing (1 mN/s, 5 seconds), and the value obtained by the analysis software (WIN-HCU developed by Fisher Instruments K.K.) was adopted as the indentation modulus of the surface layer.

The method for forming a fine relief structure on the surface of the laminate is not particularly limited, but examples thereof include a method to injection mold or press mold using a stamper having a fine relief structure formed thereon. In addition, examples of the method for forming a fine relief structure may also include a method in which an active energy ray-curable composition is filled between a stamper having a fine relief structure formed thereon and a light transmitting substrate, the active energy ray-curable composition is cured by irradiating with an active energy ray to transfer the relief shape of the stamper, and the resultant is then released from the stamper. The above method may further include adding particles to the active energy ray-curable composition to obtain an active energy ray-curable composition containing particles.

In other words, examples of the method for forming a fine relief structure on the surface of the laminate include a method which include filling an active energy ray-curable composition between a stamper having a fine relief structure formed thereon and a light transmitting substrate, irradiating the active energy ray-curable composition filled with an active energy ray, curing the active energy ray-curable composition through the active energy ray irradiation to transfer the relief shape of the stamper, and releasing the cured product on which the relief shape of the stamper has been transferred and the light transmitting substrate from the stamper.

The above method may further include adding particles to the active energy ray-curable composition to obtain an active energy ray-curable composition containing particles.

In addition, examples of the method for forming a fine relief structure on the surface of the laminate may also include a method in which an active energy ray-curable composition is filled between a stamper having a fine relief structure formed thereon and a light transmitting substrate, the active energy ray-curable composition is released from the stamper after transferring the relief shape of the stamper thereto, and the active energy ray-curable composition is then cured by irradiating with an active energy ray. The above method may further include adding particles to the active energy ray-curable composition to obtain an active energy ray-curable composition containing particles.

In other words, examples of the method for forming a fine relief structure on the surface of the laminate may also include a method which include filling an active energy ray-curable composition between a stamper having a fine relief structure formed thereon and a light transmitting substrate, transferring the fine relief shape of the stamper to the active energy ray-curable composition filled, releasing the active energy ray-curable composition having the fine relief shape transferred thereto from the stamper, and curing the active energy ray-curable composition released by irradiating with an active energy ray.

The above method may further include adding particles to the active energy ray-curable composition to obtain an active energy ray-curable composition containing particles.

Among these, a method in which an active energy ray-curable composition is filled between a stamper having a fine relief structure formed thereon and a light transmitting substrate, the active energy ray-curable composition is cured by irradiating with an active energy ray to transfer the relief shape of the stamper, and the resultant is then released from the stamper is preferably used in consideration of the transferability of the fine relief structure and the degree of freedom of the surface composition. The above method may further include adding particles to the active energy ray-curable composition to obtain an active energy ray-curable composition containing particles.

In other words, as the method for forming a fine relief structure on the surface of the laminate, a method which include filling an active energy ray-curable composition between a stamper having a fine relief structure formed thereon and a light transmitting substrate, irradiating the active energy ray-curable composition filled with an active energy ray, curing the active energy ray-curable composition through the active energy ray irradiation to transfer the relief shape of the stamper, and releasing the cured product on which the relief shape of the stamper has been transferred and the light transmitting substrate from the stamper is preferable. The above method may further include adding particles to the active energy ray-curable composition to obtain an active energy ray-curable composition containing particles.

The substrate is not particularly limited, but it is preferably a light transmitting substrate. The light transmitting substrate is not particularly limited as long as it is a substrate which transmits light. Examples of a material of the light transmitting substrate include a methyl methacrylate (co)polymer, a polycarbonate, a styrene (co)polymer, a methyl methacrylate-styrene copolymer, cellulose diacetate, cellulose triacetate, cellulose acetate butyrate, a polyester, a polyamide, a polyimide, a polyether sulfone, a polysulfone, polypropylene, polymethylpentene, polyvinyl chloride, polyvinyl acetal, a polyether ketone, a polyurethane, glass, and rock crystal.

Among the above materials, a methyl methacrylate (co)polymer, a polycarbonate, cellulose triacetate, and a polyester are preferable.

The light transmitting substrate may be fabricated by any method of injection molding, extrusion molding, or cast molding.

The shape of the light transmitting substrate is not particularly limited, and it can be appropriately selected according to the application. The shape is preferably a sheet or a film, for example, in a case in which the application is an antireflective film. In addition, the surface of the light transmitting substrate may be subjected, for example, to various kinds of coating treatments or corona discharge treatment in order to improve the adhesion with the active energy ray-curable composition, antistatic property, abrasion resistance, weather resistance, and the like.

Incidentally, the “sheet shape” described herein means a plate shape to be 0.25 mm or more, and the “film shape” means a membrane shape to be less than 0.25 mm.

The method for fabricating a stamper having a fine relief structure formed thereon is not particularly limited, but examples thereof include an electron beam lithography method or a laser beam interference method. For example, a proper photoresist film is coated on a proper support basal plate, exposed to light such as an ultraviolet laser, an electron beam, or an X-ray, and subsequently developed, thereby forming a mold having a fine relief structure. This mold can be used as a stamper as it is. In addition, it is also possible to directly form the fine relief structure on the support basal plate itself by selectively etching the support basal plate by dry etching via the photoresist layer and then removing the photoresist layer.

In addition, it is also possible to utilize anodized porous alumina as a stamper. An alumina nano-hole array obtained by a method to anodize aluminum in an electrolytic solution such as oxalic acid, sulfuric acid, or phosphoric acid at a predetermined voltage, for example, as disclosed in JP 2005-156695 A may be utilized as a stamper. According to this method, it is possible to form pores exhibiting significantly high regularity in self-assembled manner by anodizing high purity aluminum at a constant voltage for a long time, then once removing the oxide film, and anodizing the aluminum again. Furthermore, it is also possible to form a fine relief structure having a bell-shaped concave portion other than a substantially conical shape by combining the anodizing treatment and the pore size enlarging treatment at the time of anodizing the aluminum again. In addition, a replicative mold may be fabricated from the original mold having a fine relief structure by an electroforming method or the like to use this as a stamper.

The shape of the stamper fabricated in this manner is not particularly limited, and it may be a roll or a flat plate, but it is preferably a roll from the viewpoint of being able to continuously transfer the fine relief structure to the active energy ray-curable composition.

The active energy ray-curable composition of an embodiment of the invention can appropriately contain a monomer having at least one bond selected from the group consisting of a radically polymerizable bond and a cationically polymerizable bond in the molecule, a polymer having a low degree of polymerization, and a reactive polymer. In addition, the active energy ray-curable composition can be cured using the polymerization initiator to be described later. In addition, the active energy ray-curable composition may contain a non-reactive polymer.

Specific examples of the active energy ray used at the time of curing the active energy ray-curable composition include visible light, ultraviolet light, an electron beam, plasma, infrared rays.

For example, a high pressure mercury lamp is used for the photoirradiation of an active energy ray. The cumulative photoirradiation energy quantity is not particularly limited as long as the energy quantity allows curing of the active energy ray-curable composition to proceed, but for example, it is preferably from 100 to 5000 mJ/cm², more preferably from 200 to 4000 mJ/cm², and even more preferably from 400 to 3200 mJ/cm². The cumulative photoirradiation quantity of the active energy ray affects the degree of cure of the active energy ray-curable composition in some cases, and thus it is desirable to irradiate the active energy ray-curable composition with light by appropriately selecting the cumulative photoirradiation energy quantity.

The polymerization initiator (photopolymerization initiator) used for curing (photocuring) of the active energy ray-curable composition is not particularly limited, but examples thereof include an acetophenone such as 2,2-diethoxy acetophenone, p-dimethyl acetophenone, 1-hydroxydimethyl phenyl ketone, 1-hydroxycyclohexyl phenyl ketone, 2-methyl-4-methylthio-2-morpholinopropiophenone, or 2-benzyl-2-dimethyl-amino-1-(4-morpholino-phenyl)butanone; a benzoin such as benzoin methyl ether, benzoin toluenesulfonic acid ester, benzoin methyl ether, benzoin ethyl ether, or benzoin isopropyl ether; a benzophenone such as benzophenone, 2,4-dichlorobenzophenone, 4,4-dichlorobenzophenone, or p-chlorobenzophenone; a phosphine oxide such as 2,4,6-trimethylbenzoyldiphenylphosphine oxide; a ketal; an anthraquinone; a thioxanthone; an azo compound; a peroxide; a 2,3-dialkyldione compound; a disulfide compound; a fluoroamine compound; and an aromatic sulfonium. Among the above ones, an acetophenone or a phosphine oxide is preferable. These photopolymerization initiators may be used singly or two or more kinds thereof may be used concurrently. The amount of the photopolymerization initiator added is preferably from 0.1 to 5 parts by weight.

In addition, the active energy ray-curable composition may be cured by concurrently using photocuring and heat curing. The thermal polymerization initiator added in the case of concurrently using heat curing is not particularly limited, but examples thereof include an azo compound such as 2,2′-azobis(4-methoxy-2,4-dimethylvaleronitrile), 2,2′-azobis(2,4-dimethylvaleronitrile), 2,2′-azobis(2-methylpropionitrile), 2,2′-azobis(2-methylbutyronitrile), 1,1′-azobis(cyclohexane-1-carbonitrile), 1-[(1-cyano-1-methylethyl)azo]formamide, 2-phenylazo-4-methoxy-2,4-dimethylvaleronitrile, or dimethyl 2,2′-azobis(2-methylpropionate); and a peroxide such as benzoyl peroxide, t-hexyl peroxyneodecanoate, di-(3-methyl-3-methoxybutyl) peroxydicarbonate, t-butyl peroxyneodecanoate, 2,4-dichlorobenzoyl peroxide, t-hexyl peroxypivalate, t-butyl peroxypivalate, 3,5,5-trimethylhexanoyl peroxide, octanoyl peroxide, decanoyl peroxide, lauroyl peroxide, cumyl peroxyoctanoate, succinic acid peroxide, acetyl peroxide, t-butyl peroxyisobutyrate, 1,1′-bis(t-butylperoxy)-3,3,5-trimethylcyclohexane, 1,1′-bis(t-butylperoxy)cyclohexane, t-butyl peroxybenzoate, or dicumyl peroxide. Among the above ones, an azo compound is preferable.

These thermal polymerization initiators may be used singly or two or more kinds thereof may be used concurrently.

The amount of the thermal polymerization initiator added is preferably from 0.1 to 5 parts by weight.

The laminate of an embodiment of the invention can be used in applications such as an antireflective article including an antireflective membrane (including an antireflective film) or an antireflective body, an image display device (video device), a touch panel, an optical waveguide, a relief hologram, a solar cell, a lens, a polarization separation element, an optical article such as a member for improving the light extraction efficiency of the organic electroluminescence, and a cell culture sheet.

The laminate of an embodiment of the invention is particularly suitable for an antireflective article such as an antireflective membrane (including an antireflective film) or an antireflective body.

The laminate of an embodiment of the invention is a laminate equipped with a surface layer having a uniform film thickness and exhibits favorable abrasion resistance, and thus the laminate of an embodiment of the invention has a favorable appearance and can exert favorable antireflective performance including excellent durability at the time of being used when it is disposed on the outermost surface of an antireflective article, an image display device, a touch panel, and the like.

In a case in which the antireflective article has a film shape, for example, it is used by being pasted on the surface of an object such as an image display device including a liquid crystal display device, a plasma display panel, an electroluminescence display, or a cathode ray tube display; a lens; a show window; a meter cover of a motor vehicle; and a spectacle lens.

In a case in which the antireflective article has a three-dimensional shape, the laminate is produced using a light transmitting substrate having a shape corresponding to the application in advance and this can be used as a member constituting the surface of the above object.

In addition, in a case in which the object is an image display device, the antireflective article may be pasted not only to its surface but also to its front plate or the front plate itself may be constituted by the laminate of the invention.

As another aspect of the invention, a laminate is mentioned which includes

a substrate and a surface layer laminated on the substrate and in which

a fine relief structure is formed on a surface of the surface layer on a side opposite to a substrate side and

the surface layer is a cured product obtained by curing an active energy ray-curable composition, in which

the active energy ray-curable composition contains particles having an average particle size to be equal to or greater than 80% of an average interval between adjacent convex portions of the fine relief structure, where the average interval is 100%, in which

the particles are at least one selected from the group consisting of silica (SiO₂), titanium dioxide (TiO₂), and a polymer containing at least one selected from the group consisting of methyl methacrylate and styrene.

As another aspect of the invention, a laminate is mentioned which includes

a substrate and a surface layer laminated on the substrate and in which

a fine relief structure is formed on a surface of the surface layer on a side opposite to a substrate side and

the surface layer is a cured product obtained by curing an active energy ray-curable composition, in which

the active energy ray-curable composition contains particles having an average particle size to be equal to or greater than 80% of an average interval between adjacent convex portions of the fine relief structure, where the average interval is 100%, in which

the particles are at least one selected from the group consisting of silica (SiO₂), titanium dioxide (TiO₂), and a polymer containing at least one selected from the group consisting of methyl methacrylate and styrene and

a content of the particles is from 1 to 70 parts by mass with respect to 100 parts by mass of the active energy ray-curable composition.

As another aspect of the invention, a laminate is mentioned which includes

a substrate and a surface layer laminated on the substrate and in which

a fine relief structure is formed on a surface of the surface layer on a side opposite to a substrate side and

the surface layer is a cured product obtained by curing an active energy ray-curable composition, in which

the active energy ray-curable composition contains particles having an average particle size to be equal to or greater than 80% of an average interval between adjacent convex portions of the fine relief structure, where the average interval is 100%, in which

the particles are at least one selected from the group consisting of silica (SiO₂), titanium dioxide (TiO₂), and a polymer containing at least one selected from the group consisting of methyl methacrylate and styrene and

a content of the particles is from 1 to 70 parts by mass with respect to 100 parts by mass of the active energy ray-curable composition, and

the active energy ray-curable composition contains a trifunctional or higher polyfunctional (meth)acrylate (A) at from 10 to 60 parts by mass and a bifunctional (meth)acrylate (B) at from 40 to 90 parts by mass where a total amount of polymerizable components of the active energy ray-curable composition is 100 parts by mass.

### EXAMPLES

Hereinafter, the invention will be specifically described with reference to Examples, but the invention is not limited thereto.

<Methods of Various Kinds of Evaluation and Measurements>

(Measurement of Uniformity of Film Thickness)

The thickness of the surface layer (namely, the vertical distance from the tip portion of the convex portion of the fine relief structure formed on the surface layer to the interface between the surface layer and the substrate) was measured at arbitrary 5 points of the laminate using a thickness meter (ABS Digimatic Indicator ID-F125 manufactured by Mitutoyo Corporation), and A was granted in a case in which the deviation of the respective values measured was 1 μm or less and B was granted in a case in which the deviation exceeded 1 μm.

(Measurement of Abrasion Resistance)

The surface layer was rubbed with the K-Dry (manufactured by NIPPON PAPER CRECIA Co., LTD.) at a pressure of 100 g/cm², the presence or absence of stripe-shaped scratches was visually observed under a fluorescent light, and A was granted in a case in which scratches were not confirmed and B was granted in a case in which scratches were confirmed.

(Measurement of Transparency)

The haze of a sample prepared by pasting the laminate to the glass plate S9112 (manufactured by Matsunami Glass Ind., Ltd.) via a transparent pressure sensitive adhesive (OPTERIA MO-3006C manufactured by Lintec Corporation) was measured using the HAZE METER NDH200 (manufactured by NIPPON DENSHOKU INDUSTRIES Co., LTD.) in conformity with JIS-K7136. A was granted to those which had a haze of less than 10% and B was granted to those which had a haze of 10% or more.

(Observation of Sample Surface by Electron Microscope)

The fine relief structure formed on the surface of the stamper and the laminate was observed using a scanning electron microscope (“JSM-7400F” manufactured by JEOL Ltd.) under a condition of an acceleration voltage of 3.00 kV. Incidentally, for the observation of the laminate, the laminate was deposited with platinum for 10 minutes and then subjected to the observation. From the images thus obtained, the distance (interval) between the adjacent convex portions and the height of the convex portions were measured at 10 points, respectively, and the average values thereof were determined

<Fabrication of Stamper>

An electropolished aluminum disc (purity of 99.99% by mass, thickness of 2 mm, φ 65 mm) was used as the aluminum substrate. The aluminum substrate was immersed in a 0.3 M aqueous solution of oxalic acid adjusted to 15° C., and the aluminum substrate was anodized by allowing an electric current to intermittently flow to the aluminum substrate by repeatedly ON/OFF the power supply of the direct current stabilizer. Next, an operation to apply a constant voltage of 80 V for 5 seconds every 30 seconds was repeated 60 times to form an oxide film having pores on the aluminum substrate. Subsequently, the aluminum substrate having the oxide film formed thereon was immersed in an aqueous solution prepared by mixing 6% by mass phosphoric acid and 1.8% by mass chromic acid at 70° C. for 6 hours to dissolve and remove the oxide film. The aluminum substrate from which the oxide film was dissolved and removed was immersed in a 0.05 M aqueous solution of oxalic acid adjusted to 16° C. and anodized at 80 V for 5 seconds. Subsequently, the aluminum substrate was immersed in a 5% by mass aqueous solution of phosphoric acid adjusted to 32° C. for 20 minutes to conduct the pore size enlarging treatment to enlarge the pores of the oxide film. In this manner, the anodizing treatment and the pore size enlarging treatment were alternately repeated. The anodizing treatment and the pore size enlarging treatment were conducted 5 times for each. The stamper thus obtained was immersed in a 0.1% by mass aqueous solution of the TDP-8 (manufactured by Nikko Chemicals Co., Ltd.) for 10 minutes, then withdrawn therefrom, and dried for the night, thereby conducting the mold releasing treatment.

The surface of porous alumina thus obtained was observed using an electron microscope to confirm that a fine relief structure composed of a tapered concave portion having a distance (interval) between the adjacent convex portions of 180 nm, a depth of 150 nm, and a substantially conical shape was formed.

### Example 1

### Production of Laminate

The active energy ray-curable composition was prepared by mixing the following materials.
Ethylene oxide-modified dipentaerythritol hexaacrylate (“KAYARAD DPEA-12”, number of ethylene oxide structural unit in one molecule, n=12, manufactured by Nippon Kayaku Co., Ltd.): 50 parts by mass
Aronix M-260 (trade name, manufactured by TOAGOSEI CO., LTD., average repeating unit of polyethylene glycol chain of 13): 50 parts by mass
SO-E1 (trade name, silica particles, average particle size of 250 nm, manufactured by ADMATECHS CO., LTD.): 5 parts by mass
Irgacure 184 (trade name, manufactured by BASF): 1 part by mass
Irgacure 819 (trade name, manufactured by BASF): 0.5 part by mass
TDP-2 (trade name, manufactured by Nikko Chemicals Co., Ltd.): 0.1 part by mass

Few drops of the active energy ray-curable composition was dropped on the stamper and coated while pushing and spreading with a triacetyl cellulose film (FTTD80ULM (trade name), manufactured by FUJIFILM Corporation). Subsequently, the active energy ray-curable composition was irradiated with ultraviolet light at a cumulative photoirradiation energy quantity of 1000 mJ/cm² from the film side so as to be cured. As illustrated in FIG. 1, a laminate was obtained which had a fine relief structure having an average interval between the adjacent convex portions, w1, of 180 nm and an average height of the convex portions, d1, of 150 nm.

<Evaluation>

The laminate thus obtained was subjected to various kinds of evaluation of uniformity of the film thickness of the surface layer, abrasion resistance, and transparency. The laminate thus obtained had a surface layer with a uniform film thickness and exhibited favorable abrasion resistance. The results are presented in Table 1.

TABLE 1

| | Silica fine particles | | | | | | TiO₂ | Acrylic fine particles | | | | | | | Evaluation result | | |
|---|---|---|---|---|---|---|---|---|---|---|---|---|---|---|---|---|---|
| | SO- | SO- | SO- | SO- | SO- | AERO- | ST- | XX- | SSX- | XX- | MBX- | SSX- | SSX- | XX- | Uni- | Abra- | |
| | E1 | E2 | E3 | E5 | E6 | SIL300 | 41 | 119B | 101 | 109B | 5 | 105 | 110 | 115B | formity | sion | |
| | Particle size (nm) | | | | | | | | | | | | | | of film | resis- | Trans- |
| | 250 | 500 | 1000 | 1500 | 2000 | 7 | 200 | 270 | 220 | 380 | 1590 | 450 | 690 | 24 | thickness | tance | parency |
| Example 1 | 5 | 0 | 0 | 0 | 0 | 0 | 0 | 0 | 0 | 0 | 0 | 0 | 0 | 0 | A | A | A |
| Example 2 | 0 | 5 | 0 | 0 | 0 | 0 | 0 | 0 | 0 | 0 | 0 | 0 | 0 | 0 | A | A | A |
| Example 3 | 0 | 0 | 5 | 0 | 0 | 0 | 0 | 0 | 0 | 0 | 0 | 0 | 0 | 0 | A | A | B |
| Example 4 | 0 | 0 | 0 | 5 | 0 | 0 | 0 | 0 | 0 | 0 | 0 | 0 | 0 | 0 | A | A | B |
| Example 5 | 0 | 0 | 0 | 0 | 5 | 0 | 0 | 0 | 0 | 0 | 0 | 0 | 0 | 0 | A | A | B |
| Example 6 | 0 | 0 | 0 | 0 | 0 | 0 | 5 | 0 | 0 | 0 | 0 | 0 | 0 | 0 | A | A | A |
| Example 7 | 0 | 0 | 0 | 0 | 0 | 0 | 0 | 5 | 0 | 0 | 0 | 0 | 0 | 0 | A | A | A |
| Example 8 | 0 | 0 | 0 | 0 | 0 | 0 | 0 | 35 | 0 | 0 | 0 | 0 | 0 | 0 | A | A | A |
| Example 9 | 0 | 0 | 0 | 0 | 0 | 0 | 0 | 65 | 0 | 0 | 0 | 0 | 0 | 0 | A | A | A |
| Example 10 | 0 | 0 | 0 | 0 | 0 | 0 | 0 | 0 | 5 | 0 | 0 | 0 | 0 | 0 | A | A | A |
| Example 11 | 0 | 0 | 0 | 0 | 0 | 0 | 0 | 0 | 0 | 5 | 0 | 0 | 0 | 0 | A | A | A |
| Example 12 | 0 | 0 | 0 | 0 | 0 | 0 | 0 | 0 | 0 | 0 | 5 | 0 | 0 | 0 | A | A | B |
| Example 13 | 0 | 0 | 0 | 0 | 0 | 0 | 0 | 0 | 0 | 0 | 0 | 5 | 0 | 0 | A | A | A |
| Example 14 | 0 | 0 | 0 | 0 | 0 | 0 | 0 | 0 | 0 | 0 | 0 | 0 | 5 | 0 | A | A | B |
| Comparative | 0 | 0 | 0 | 0 | 0 | 0 | 0 | 0 | 0 | 0 | 0 | 0 | 0 | 0 | B | A | A |
| Example 1 | | | | | | | | | | | | | | | | | |
| Comparative | 0 | 0 | 0 | 0 | 0 | 5 | 0 | 0 | 0 | 0 | 0 | 0 | 0 | 0 | A | B | A |
| Example 2 | | | | | | | | | | | | | | | | | |
| Comparative | 0 | 0 | 0 | 0 | 0 | 0 | 0 | 0 | 0 | 0 | 0 | 0 | 0 | 5 | A | B | A |
| Example 3 | | | | | | | | | | | | | | | | | |

The abbreviations in Table 1 are as follows.
SO-E1: (trade name, silica particles, average particle size of 250 nm, manufactured by ADMATECHS CO., LTD.)
SO-E2: (trade name, silica particles, average particle size of 500 nm, manufactured by ADMATECHS CO., LTD.)
SO-E3: (trade name, silica particles, average particle size of 1000 nm, manufactured by ADMATECHS CO., LTD.)
SO-E5: (trade name, silica particles, average particle size of 1500 nm, manufactured by ADMATECHS CO., LTD.)
SO-E6: (trade name, silica particles, average particle size of 2000 nm, manufactured by ADMATECHS CO., LTD.)
AEROSIL300: (trade name, silica particles, average particle size of 7 nm, manufactured by EVONIK INDUSTRIES)
ST-41: (trade name, titanium dioxide particles, average particle size of 200 nm, manufactured by ISHIHARA SANGYO KAISHA LTD.)
XX-119B: (trade name, polymer particles, average particle size of 270 nm, manufactured by SEKISUI PLASTICS CO., LTD.)
SSX-101: (trade name, polymer particles, average particle size of 220 nm, manufactured by SEKISUI PLASTICS CO., LTD.)
XX-109B: (trade name, polymer particles, average particle size of 380 nm, manufactured by SEKISUI PLASTICS CO., LTD.)
MBX-5: (trade name, polymer particles, average particle size of 1590 nm, manufactured by SEKISUI PLASTICS CO., LTD.)
SSX-105: (trade name, polymer particles, average particle size of 450 nm, manufactured by SEKISUI PLASTICS CO., LTD.)
SSX-110: (trade name, polymer particles, average particle size of 690 nm, manufactured by SEKISUI PLASTICS CO., LTD.)
XX-115B: (trade name, polymer particles, average particle size of 270 nm, manufactured by SEKISUI PLASTICS CO., LTD.)

### Examples 2 to 14

The laminates were obtained in the same manner as in Example 1 except that the composition was changed to those presented in Table 1. The results are presented in Table 1. In the laminates obtained in Examples 2 to 14, the uniformity of the film thickness of the surface layer and the abrasion resistance were favorable.

### Comparative Examples 1 to 3

The laminates were obtained in the same manner as in Example 1 except that the composition was changed to those presented in Table 1. The results are presented in Table 1. Comparative Example 1 was inferior in uniformity of the film thickness of the surface layer since particles were not contained. Comparative Examples 2 and 3 were inferior in abrasion resistance since the average particle size of the particles was less than 80% of the interval between the adjacent convex portions of the fine relief structure and thus the particles penetrated into the convex portions.

### INDUSTRIAL APPLICABILITY

The laminate of an embodiment of the invention is significantly industrially useful since it has a favorable appearance and exhibits excellent abrasion resistance while maintaining excellent optical performance and thus it can be usable in various kinds of displays such as a television, a cellular phone, and a portable game console, a touch panel, a showcase, an exterior cover, and the like.

### EXPLANATIONS OF LETTERS OR NUMERALS

10: Laminate
11: Substrate
12: Surface layer
13: Convex portion
14: Concave portion
15: Transparent adhesive layer
16: Transparent glass body
17: Video display member
18: Void portion
19: Transparent electrode laminated member
20: Touch panel member
21: Support member

1. A laminate comprising:
a substrate;
a surface layer laminated on the substrate;
a fine relief structure which has a plurality of convex portions and is formed on a surface of the surface layer on a side opposite to a substrate side, an average interval between the adjacent convex portions is equal to or less than the wavelength of visible light; and
a plurality of particles having an average particle size to be equal to or greater than 80% of an average interval between adjacent convex portions of the fine relief structure, where the average interval is 100%,
wherein
the surface layer and the fine relief structure are cured products of an active energy ray-curable composition, and
a plurality of particles are arranged in the surface layer.

2. The laminate according to claim 1, wherein the average particle size is from 100 to 1200% of the average interval between the adjacent convex portions of the fine relief structure, where the average interval is 100%.

3. The laminate according to claim 1, wherein the average interval between the adjacent convex portions of the fine relief structure is 25 nm or more and 400 nm or less.

4. The laminate according to claim 1, wherein the average particle size is from 80 to 2200 nm and the average interval between the adjacent convex portions is from 100 to 250 nm.

5. The laminate according to claim 1, wherein the particles are at least one selected from the group consisting of silica (SiO2), titanium dioxide (TiO2), and a polymer containing at least one selected from the group consisting of methyl methacrylate and styrene.

6. The laminate according to claim 1, wherein a shape of the convex portion of the fine relief structure has a structure in which an occupancy rate of a cross-sectional area at the time of cutting a convex portion of the fine relief structure in a direction orthogonal to a height direction of the laminate continuously increases from a tip portion side of the convex portion of the fine relief structure toward a substrate side.

7. The laminate according to claim 1, wherein the active energy ray-curable composition contains the particles, and a content of the particles is from 1 to 70 parts by mass with respect to 100 parts by mass of the active energy ray-curable composition.

8. The laminate according to claim 1, wherein the active energy ray-curable composition has a content of a trifunctional or higher polyfunctional (meth)acrylate of 10 parts by mass or more and 60 parts by mass or less and a content of a bifunctional (meth)acrylate of 40 parts by mass or more and 90 parts by mass or less where a total amount of polymerizable components of the active energy ray-curable composition is 100 parts by mass.

9. An antireflective article comprising the laminate according to claim 1.

10. A video device comprising the laminate according to claim 1.

11. A touch panel comprising the laminate according to claim 1.
